(19) United States
(12) Patent Application Publication
(10) Pub. No.: US 2026/0362387 A1
(43) Pub. Date: Nov. 12, 2026

(54) SYSTEM AND METHOD FOR MULTI-HOP RANGING ACROSS HETEROGENEOUS COMMUNICATION PROTOCOL

(71) Applicant: GM Global Technology Operations LLC, Detroit, MI (US)

(72) Inventors: Venkata Naga Siva Vikas Vemuri, Farmington Hills, MI (US); Azin Neishaboori, Plymouth, MI (US); Ahmed F. Al Alawy, Canton, MI (US)

(21) Appl. No.: 19/203,967

(22) Filed: May 9, 2025

(51) Int. Cl. H04W 64/00; H04W 48/20; H04B 1/7163; H04W 84/12

(52) U.S. Cl. CPC H04W 64/006; H04W 48/20; H04B 1/7163; H04W 84/12

(57) ABSTRACT

A method of performing multi-hop ranging between an initiator device and a target device includes the initiator device generating a ranging request. The initiator device communicates the ranging request to a first hop node using a first wireless technology. The method further includes the first hop node receiving the ranging request and translating the ranging request by mapping. The method further includes propagating the translated ranging request from the first hop node to one or more additional hop nodes. Each additional hop node generates an updated translated ranging request forwarding the updated translated ranging request. The method further includes the target device receiving the translated ranging request and generating a ranging response. The method further includes propagating the ranging response from the target device back to the initiator device. The method further includes the initiator device computing a range between the initiator device and the target device.

### INTRODUCTION

The present disclosure relates to wireless ranging in Internet-of-Things (IoT) environments and, more specifically, to a system and method for multi-hop ranging across heterogeneous communication protocol.

IoT ranging solutions assume that the initiating device and the target device share the same radio interface and are within direct radio-frequency (RF) proximity. When those conditions are not met, such as when a vehicle approaches a home garage door opener that is still out of Wi-Fi range, existing protocols simply wait until the devices move closer or until a single-technology link can be established.

However, while mesh networking standards can forward data over multiple hops, they cannot convert ranging parameters between different communication protocol. As a result, current solutions cannot seamlessly bridge a ranging session that starts, for example, on Wi-Fi, transits through a mixed Wi-Fi/UWB node, and terminates on a UWB only device. Accordingly, there is a need for a multi-hop ranging approach that overcomes these limitations.

### SUMMARY

According to several aspects, a method of performing multi-hop ranging between an initiator device and a target device is provided. The method includes generating, at the initiator device that operates according to a first communication protocol, a ranging request. The ranging request includes a target identifier, a hop-count field, and communication protocol ranging parameters. The communication protocol ranging parameters include a minimum ranging-interval limit, a maximum stable working range, a linear fitted slope, a systemic bias value, and a ranging-result error value. The method further includes communicating the ranging request from the initiator device using a first wireless technology. The method further includes receiving, at a first hop node that concurrently supports the first communication protocol and a second communication protocol, the ranging request. The method further includes generating a translated ranging request by mapping, at the first hop node, the communication protocol ranging parameters to second communication protocol ranging parameters using a mapping protocol. The method further includes propagating the translated ranging request from the first hop node to one or more additional hop nodes. Each additional hop node generates an updated translated ranging request between supported communication protocol and forwarding the updated translated ranging request. The method further includes receiving, at the target device, the updated translated ranging request using a final communication protocol. The method further includes generating, at the target device, a ranging response. The ranging response includes a ranging response confirmation and timing information related to when the updated translated ranging request was received. The method further includes propagating the ranging response from the target device back to the initiator device along the same or an alternative set of hop nodes, each hop node generating a translated ranging response between supported communication protocol. The method further includes computing, at the initiator device, a range between the initiator device and the target device based on the timing information contained in the translated ranging response.

In an additional aspect of the present disclosure, the first hop node selects the second communication protocol from a group of candidate communication protocol based on an energy level of the one or more additional hop nodes, an available bandwidth related to the candidate communication protocol, and congestion of the candidate communication protocol.

In another aspect of the present disclosure, the method further includes updating, at the first hop node and at each of the one or more additional hop nodes, the hop-count field and forwarding the translated ranging request toward the target device using the second communication protocol.

In another aspect of the present disclosure, updating the hop-count field comprises incrementing a hop counter and discarding the translated ranging request when the hop counter exceeds a predefined maximum hop limit.

In another aspect of the present disclosure, the first communication protocol is Wi-Fi, the second communication protocol is Ultra-Wideband™ (UWB), and the final communication protocol is Bluetooth® Low Energy (BLE).

In another aspect of the present disclosure, the method further includes authenticating, at each hop node, the ranging request and the ranging response.

In another aspect of the present disclosure, at least one hop node is a master node and when no downstream hop node is responsive to the translated ranging request, the master node selects another hop node, and the translated ranging request is re-broadcast.

In another aspect of the present disclosure, the initiator device includes a node priority list maintained.

In another aspect of the present disclosure, the communication protocol ranging parameters further include a ranging ID, a hop range maximum distance, and a node retry limit.

According to several aspects, a networked ecosystem is provided. The networked ecosystem includes an initiator device that supports a first communication protocol. The networked ecosystem further includes a target device that supports a second communication protocol. The networked ecosystem further include a first hop node that concurrently supports the first communication protocol and the second communication protocol, ranging parameters between an initiator device and a target device. The networked ecosystem is configured to generate, at the initiator device that operates according to a first communication protocol, a ranging request that includes a target identifier, a hop-count field, and communication protocol ranging parameters. The communication protocol ranging parameters includes a minimum ranging-interval limit, a maximum stable working range, a linear fitted slope, a systemic bias value, and a ranging-result error value. The networked ecosystem is further configured to communicate the ranging request from the initiator device using a first wireless technology. The networked ecosystem is further configured to receive, at a first hop node that concurrently supports the first communication protocol and a second communication protocol, the ranging request. The networked ecosystem is further configured to generate a translated ranging request by mapping, at the first hop node, the communication protocol ranging parameters to second communication protocol ranging parameters using a mapping protocol. The networked ecosystem is further configured to propagate the translated ranging request from the first hop node to one or more additional hop nodes. Each additional hop node generates an updated translated ranging request between supported communication protocol and forwards the updated translated ranging request. The networked ecosystem is further configured to receive, at the target device, the updated translated ranging request using a final communication protocol. The networked ecosystem is further configured to generate, at the target device, a ranging response that includes a ranging response confirmation and timing information related to when the updated translated ranging request was received. The networked ecosystem is further configured to propagate the ranging response from the target device back to the initiator device along the same or an alternative set of hop nodes. Each hop node generates a translated ranging response between supported communication protocols. The networked ecosystem is further configured to compute, at the initiator device, a range between the initiator device and the target device based on the timing information contained in the translated ranging response.

In another aspect of the present disclosure, the first hop node selects the second communication protocol from a group of candidate communication protocol based on an energy level of the one or more additional hop nodes, an available bandwidth related to the candidate communication protocol, and congestion of the candidate communication protocol.

In another aspect of the present disclosure, the networked ecosystem further includes updating, at the first hop node and at each of the one or more additional hop nodes, the hop-count field and forwarding the translated ranging request toward the target device using the second communication protocol.

In another aspect of the present disclosure, updating the hop-count field comprises incrementing a hop counter and discarding the translated ranging request when the hop counter exceeds a predefined maximum hop limit.

In another aspect of the present disclosure, the first communication protocol is Wi-Fi, the second communication protocol is Ultra-Wideband™ (UWB), and the final communication protocol is Bluetooth® Low Energy (BLE).

In another aspect of the present disclosure, the networked ecosystem further includes authenticating, at each hop node, the ranging request and the ranging response.

In another aspect of the present disclosure, wherein at least one hop is a master node and when no downstream hop node is responsive to the translated ranging request, the master node selects another hop node, and the translated ranging request is re-broadcast.

In another aspect of the present disclosure, the initiator device includes a node priority list maintained.

In another aspect of the present disclosure, the communication protocol ranging parameters further include a ranging ID, a hop range maximum distance, and a node retry limit.

According to several aspects, tangible, non-transitory, machine-readable mediums is provided. The tangible, non-transitory, machine-readable mediums includes machine-readable instructions. When the machine-readable instructions are executed by one or more processors, cause the processors to generate, at an initiator device that operates according to a first communication protocol, a ranging request that includes a target identifier, a hop-count field, and communication protocol ranging parameters. The communication protocol ranging parameters include a minimum ranging-interval limit, a maximum stable working range, a linear fitted slope, a systemic bias value, and a ranging-result error value. The machine-readable instructions further cause the processor to communicate the ranging request from the initiator device using a first wireless technology. The machine-readable instructions further cause the processor to receive, at a first hop node that concurrently supports the first communication protocol and a second communication protocol, the ranging request. The machine-readable instructions further cause the processor to generate a translated ranging request by mapping, at the first hop node, the communication protocol ranging parameters to second communication protocol ranging parameters using a mapping protocol. The machine-readable instructions further cause the processor to propagate the translated ranging request from the first hop node to one or more additional hop nodes. Each additional hop node generates an updated translated ranging request between supported communication protocol and forwarding the updated translated ranging request. The machine-readable instructions further cause the processor to receive, at a target device, the updated translated ranging request using a final communication protocol. The machine-readable instructions further cause the processor to generate, at the target device, a ranging response that includes a ranging response confirmation and timing information related to when the updated translated ranging request was received. The machine-readable instructions further cause the processor to propagate the ranging response from the target device back to the initiator device along the same or an alternative set of hop nodes, each hop node generating a translated ranging response between supported communication protocol. The machine-readable instructions further cause the processor to compute, at the initiator device, a range between the initiator device and the target device based on the timing information contained in the translated ranging response.

In another aspect of the present disclosure, the first hop node selects the second communication protocol from a group of candidate communication protocol based on an energy level of the one or more additional hop nodes, an available bandwidth related to the candidate communication protocol, and congestion of the candidate communication protocol.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic drawing of an internet of things (IoT) for multi-hop ranging according to an exemplary embodiment.

FIG. 2 is a flowchart for a method of multi-hop ranging according to an exemplary embodiment.

### DETAILED DESCRIPTION

The following description is merely exemplary in nature and is not intended to limit the present disclosure, application, or uses.

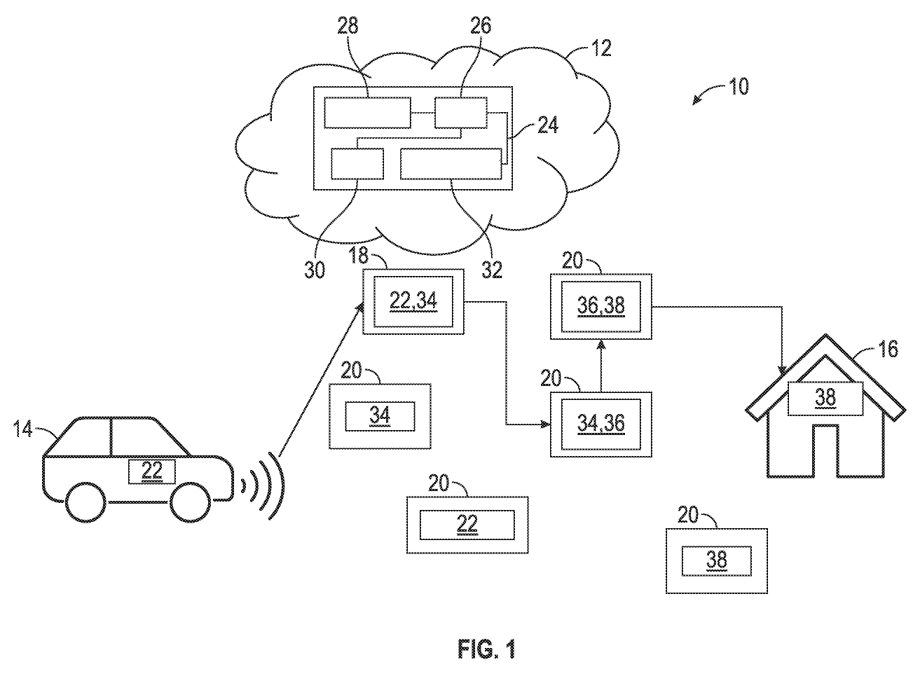

Referring to FIG. 1, a schematic drawing of an internet of things (IoT) 10 for multi-hop ranging is illustrated. The IoT 10 is a network of nodes and a cloud 12 that communicate and exchange data wirelessly through wireless technology including a communication protocol such as, but not limited to, Wi-Fi, Bluetooth®, cellular networks, Ultra-Wideband ™ (UWB), and Bluetooth® Low Energy (BLE). Each of the nodes are interconnected devices and may be equipped with one or more communication protocol, supporting communication between the nodes with like communication protocol. The nodes in the IoT 10 may be a master nodes or transit nodes. The master nodes may be controllers or devices that control and manage network operations within the IoT 10. The transit nodes act as intermediaries and forwards data between other nodes. The nodes illustrated in FIG. 1 include an initiator device 14, a target device 16, a first hop node 18, and one or more additional hop nodes 20.

The initiator device 14 generates a ranging request to be received at the target device 16, requesting a response from the target device 16. The ranging request is described in further detail below. To transmit the ranging request from the initiator device 14, the initiator device 14 supports a first communication protocol 22. The initiator device 14 broadcasts the ranging request using the first communication protocol 22 until it reaches one of the nodes in the IoT 10 that supports the first communication protocol 22 and is within a hop range maximum distance. The in The hop range maximum distance is about 100 meters (m). In this context, the term “about” is known to those skilled in the art. Alternatively, the term “about” may be read to mean plus or minus 5m. Therefore, if the target device 16 supports the first communication protocol 22 and is within the maximum hop range distance, the initiator device 14 transmits the ranging request to the target device 16. Alternatively, if the target device 16 does not support the first communication protocol 22 and/or is not within the maximum hop range distance, the initiator device 14 will transmit the ranging request to the first hop node 18 that supports the first communication protocol 22 and is within the maximum hop range distance.

To select the first hop node 18 within the IoT 10, the cloud 12 and the initiator device 14 work in parallel. The cloud 12 has a controller 24, calculating optimal paths for the ranging request to travel based on a location of each of the nodes and the communication protocol supported. The controller 24 is a non-generalized electronic control device having a preprogrammed digital computer or processor 26, a memory 28, an input and output ports 30, and a transceiver 32.

The processor 26 can be a custom made or a commercially available processor, a central processing unit (CPU), a graphics processing unit (GPU), an auxiliary processor among several processors associated with the controller 24, a semiconductor-based microprocessor (in the form of a microchip or chip set), a macroprocessor, a combination thereof, or generally a device for executing instructions. The memory 28 is used to store and record data from each of the nodes in the IoT 10, including the communication protocol supported and the location of each of the nodes. The memory 28 further stores control logic, software applications, instructions, computer code, data, lookup tables, etc. The memory 28 includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

The input and output ports 30 receive incoming data from each of the nodes in the IoT 10. The incoming data is communicated to the processor 26. The processor 26 processes the incoming data to determine optimal paths for the ranging request to travel within the IoT 10. The transceiver 32 is configured to wirelessly communicate the optimal paths to and from each of the nodes.

The initiator device 14 receives the optimal paths from the controller 24 and selects the first hop node 18 based on the optimal path. Once the first hop node 18 is selected, the first hop node 18 communicates with the controller 24 in the cloud 12 to determine the next hop based on the location of each of the nodes in the IoT 10 and the corresponding supporting communication protocol. “Hop” refers to each node in which the ranging request is transmitted to. The first hop node 18 may transmit the ranging request to the one or more additional nodes 20 or to the target device 16. The process of determining the next hop continues until the ranging request reaches the target device 16.

The ranging request includes information to assist the nodes within the IoT 10 determine the next hop, such as, a target identifier, a hop-count field, and a communication protocol ranging parameters. The target identifier notifies the first hop node 18 the identity of the target device 16, allowing the first hop node 18 to select the next hop by transmitting the ranging request to either the one or more additional hop nodes 20 or to the intended target device 16.

The hop-count field updates by incrementing a hop counter after each hop. The ranging request is discarded once the hop counter exceeds a predefined maximum hop limit to ensure reliability of the transmission with minimal interference. The predefined maximum hop limit is about 10 hops. In this context, the term “about” is known to those skilled in the art. Alternatively, the term “about” may be read to mean plus or minus 1 hop.

The communication protocol ranging parameters creates requirements for selecting the next hop. The communication protocol ranging parameters ensures the ranging request reaches the next hop while maintaining an optimal signal strength. The communication protocol ranging parameters includes a minimum ranging-interval limit, a node retry limit, a maximum stable working range, a ranging-result error value, a linear fitted slope, a hop range maximum distance, a systemic bias value, and a ranging identification (ID).

The minimum ranging interval limit defines a minimum interval in which the initiator device 14 may transmit the ranging request, ensuring the initiator device 14 does not transmit the ranging request too frequently. The minimum ranging interval limit is about one millisecond (ms). In this context, the term “about” is known to those skilled in the art. Alternatively, the term “about” may be read to mean plus or minus 0.5ms. Additionally, the node retry limits the number of attempts for each of the nodes transmitting the ranging request. The node retry limit is about 5, allowing the initiator device, or any other node in the IoT, to attempt to resend the ranging request up to 5 times before the ranging request is discarded. In this context, the term “about” is known to those skilled in the art. Alternatively, the term “about” may be read to mean plus or minus 1.

The maximum stable working range defines a range where the ranging request may maintain a consistent signal strength with minimal interference. The maximum stable working range is about 100m. In this context, the term “about” is known to those skilled in the art. Alternatively, the term “about” may be read to mean plus or minus 5m. To determine the maximum stable working range, the ranging result error value calculates the root mean square (RMS) of the average error in distance measurements. Having a lower RMS indicates more accurate ranging within the stable working range. Additionally, the linear fitted slope changes the signal strength of the transmitted ranging request. Depending on the linear fitted slope, the maximum stable working range may be affected. The hop range maximum distance is determined based on the maximum stable working range and the linear fitted slope, ensuring that the ranging request reaches the first hop node 18 while maintaining a consistent signal strength with minimal interference.

The systemic bias value considers algorithmic bias, representation bias, and design bias to determine which node to transmit the ranging request to. To differentiate between each node, each node is assigned the ranging ID, allowing the ranging request to reach the target device 16. The ranging ID assists the node transmitting the ranging request to determine which node fulfills the requirements above. To determine which node fulfills the requirement above, each hop node is authenticated. For the nodes that are authenticated, a node priority list is created and stored within the initiator device 14 to assist the cloud 12 in creating the optimal path.

Once the ranging request is received at the target device 16, the target device 16 generates the response. The response includes a ranging response confirmation and timing information related to when the ranging request was received by the target device 16. The target device 16 transmits the response to the initiator device 14. The response may travel along the same set of hop nodes to reach the initiator device 14. Alternatively, the response may travel along an alternative set of hop nodes to reach the initiator device 14. The alternative set of hop nodes may be determined by communication with the controller 24 in the cloud 12.

For example, FIG. 1 illustrates the initiator device 14 transmitting a ranging request to the target device 16 by way of multi-hop ranging. Multi-hop ranging enables communication between the initiator device 14 and the target device 16 that is not within the maximum hop range and/or does not support the same communication protocol. It is to be appreciated that FIG. 1 is merely exemplary in nature, the initiator device 14 is not limited to a vehicle and the target device 16 is not limited to a home. It should also be appreciated that if the initiator device is a vehicle, the vehicle may be any type of vehicle such as, but not limited to, a sedan, a truck, a sport utility vehicle, van, or motor home.

The initiator device 14 supports the first communication protocol 22 and is within the maximum hop distance range with a plurality of nodes. The initiator device 14 chooses the first hop node 18 by communicating with the controller 24 in the cloud 12. The first hop node supports the first communication protocol 22, supports a second communication protocol 34, and is within the maximum hop distance range. The initiator device 14 transmits the ranging request to the first hop node 18 using the first communication protocol 22. The first hop node 18 receives the ranging request and determines, with the cloud 12, the next hop.

The first hop node 18 supports the first communication protocol 22 and the second communication protocol 34. The first hop node 18 may transmit the ranging request to a group of candidate nodes that are within the maximum hop distance range and support either the first communication protocol 22 or the second communication protocol 34. The first hop node 18 chooses one of the group of candidate nodes for the next hop based on an energy level of the hop node, an available bandwidth related to the candidate communication protocol, and congestion of the candidate communication protocol.

The first hop node 18 transmits the ranging request to the one or more additional hop nodes 20. If the one or more additional hop nodes 20 is not responsive, the first hop node 18 selects a different one or more additional hop nodes 20 and re-broadcasts the ranging request. The one or more additional hop nodes 20 supports the second communication protocol 34, supports a third communication protocol 36, and is within the maximum hop distance range. To transmit the ranging request from the first hop node 18 to the one or more additional hop nodes 20, the first hop node 18 uses a mapping protocol to translate the ranging request from the first communication protocol into the third communication protocol 36.

The one or more additional hop nodes 20 transmits the ranging request to a different one or more additional hop nodes 20. The one or more additional hop nodes 20 supports the second communication protocol 34, supports a third communication protocol 36, and is within the maximum hop distance range. Due to the ranging request being transmitted to the one or more additional hop nodes 20 using the second communication protocol 34, the one or more additional nodes 20 uses the mapping protocol to transmit the ranging request to the different one or more additional hop nodes 20 using the third communication protocol 36.

The different one or more additional hop nodes 20 transmits the ranging request to the target device 16. The different one or more additional hop nodes 20 supports the third communication protocol 36, supports a final communication protocol 38, and is within the maximum hop distance range. Due to the ranging request being transmitted to the different one or more additional hop nodes 20 using the third communication protocol 36, the different one or more additional nodes 20 uses the mapping protocol to transmit the ranging request to target device 16 using the final communication protocol 38.

Once the target device 16 receives the ranging request, the target device 16 transmits the response to the request. The response includes at least a ranging request confirmation and timing information related to when the ranging request was received. The response may travel the original path of nodes or travel an alternate path of nodes. The target device 16 also computes a range after receiving the ranging request. The range is based on timing information contained in the translated ranging response, determining a distance between the initiator device 14 and the target device 16. Multi-hop ranging allows the ranging request to travel a further distance between the initiator device 14 and the target device 16 with low latency.

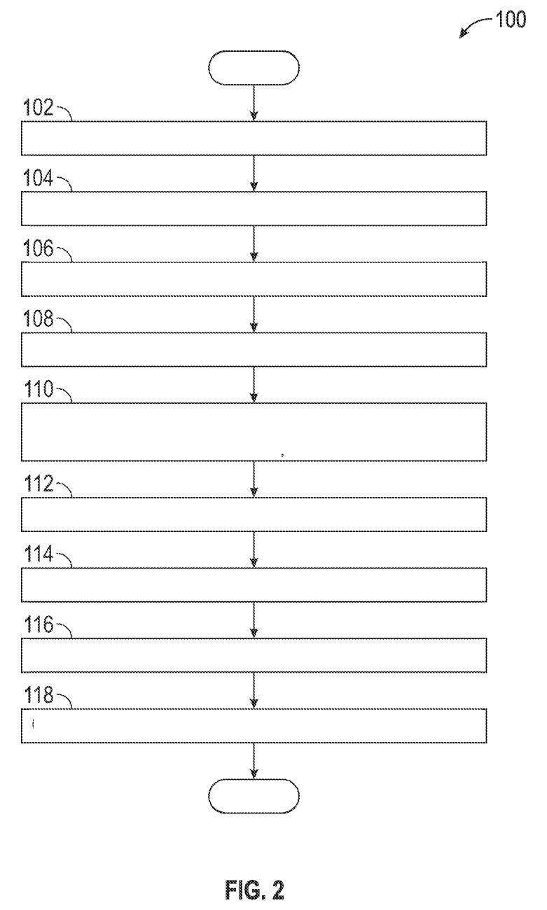

Referring to FIG. 2, a flow chart for a method 100 of multi-hop ranging is illustrated. The method 100 begins with step 102. At step 102, the initiator device 14 generates the ranging request. The method 100 proceeds with step 104. At step 104, the initiator device 14 communicates the ranging request using the first communication protocol 22. The method 100 proceeds with step 106. At step 106, the first hop node 18 receives the ranging request. The first hop node 18 concurrently supports the first communication protocol 22 as well as the second communication protocol 34. The method 100 proceeds with step 108.

At step 108, the first hop node 18 generates a translated ranging request by mapping. The translated ranging request contains the same information as the ranging request transmitted. However, the translated ranging request is now configured to be communicated with devices that support the second communication protocol 34. The method 100 proceeds with step 110.

At step 110, the first hop node 18 propagates the translated ranging request to one or more additional hop nodes 20. Each of the one or more additional hop nodes 20 may translate the ranging request to different supported communication protocol by use of mapping. The one or more additional hop nodes 20 forward the translated ranging request to the target device 16. The method 100 proceeds with step 112.

At step 112, the target device 16 receives the translated ranging request. The target device 16 supports the final communication protocol 38. The one or more additional nodes 20 that transmitted the translated ranging request to the target device 16 supports the final communication protocol 38. The one or more additional nodes 20 that transmitted the translated ranging request to the target device 16 translated the ranging request by way of mapping for the ranging request to support the final communication protocol 38. The method 100 proceeds with step 114.

At step 114, the target device 16 generates a response that includes the ranging response confirmation and timing information related to when the updated translated ranging request was received by the target device 16. The method 100 proceeds with step 116. At step 116, the target device 16 propagates the ranging response from the target device 16 back to the initiator device 14 along the same set of hop nodes. Alternatively, the target device 16 propagates the ranging response from the target device 16 back to the initiator device 14 along an alternative set of hop nodes. Each of the hop nodes generate a translated ranging response between supported communication protocol. The method 100 proceeds with step 118. At step 118, the initiator device computes a range between the initiator device 14 and the target device 16. The range is computed based on the timing information contained in the translated ranging response.

The system and method for multi-hop ranging offers several advantages. These include enabling communication between an initiator device 14 and a target device 16 that are not within the maximum hop range, increasing the total distance traveled by the ranging request with low latency. Additionally, multi-hop ranging enables communication between an initiator device 14 and a target device 16 that support different communication protocol.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of performing multi-hop ranging between an initiator device and a target device, the method comprising:
generating, at the initiator device that operates according to a first communication protocol, a ranging request that includes a target identifier, a hop-count field, and communication protocol ranging parameters, the communication protocol ranging parameters including a minimum ranging-interval limit, a maximum stable working range, a linear fitted slope, a systemic bias value, and a ranging-result error value;
communicating the ranging request from the initiator device using a first wireless technology;
receiving, at a first hop node that concurrently supports the first communication protocol and a second communication protocol, the ranging request;
generating a translated ranging request by mapping, at the first hop node, the communication protocol ranging parameters to second communication protocol ranging parameters using a mapping protocol;
propagating the translated ranging request from the first hop node to one or more additional hop nodes, each additional hop node generating an updated translated ranging request between supported communication protocol and forwarding the updated translated ranging request;
receiving, at the target device, the updated translated ranging request using a final communication protocol;
generating, at the target device, a ranging response that includes a ranging response confirmation and timing information related to when the updated translated ranging request was received;
propagating the ranging response from the target device back to the initiator device along the same or an alternative set of hop nodes, each hop node generating a translated ranging response between supported communication protocol; and
computing, at the initiator device, a range between the initiator device and the target device based on the timing information contained in the translated ranging response.

2. The method of claim 1, wherein the first hop node selects the second communication protocol from a group of candidate communication protocol based on an energy level of the one or more additional hop nodes, an available bandwidth related to the candidate communication protocol, and congestion of the candidate communication protocol.

3. The method of claim 1, further comprising updating, at the first hop node and at each of the one or more additional hop nodes, the hop-count field and forwarding the translated ranging request toward the target device using the second communication protocol.

4. The method of claim 3, wherein updating the hop-count field comprises incrementing a hop counter and discarding the translated ranging request when the hop counter exceeds a predefined maximum hop limit.

5. The method of claim 1, wherein the first communication protocol is Wi-Fi, the second communication protocol is Ultra-Wideband™ (UWB), and the final communication protocol is Bluetooth® Low Energy (BLE).

6. The method of claim 1, further comprising authenticating, at each hop node, the ranging request and the ranging response.

7. The method of claim 1, wherein at least one hop node is a master node and when no downstream hop node is responsive to the translated ranging request, the master node selects another hop node, and the translated ranging request is re-broadcast.

8. The method of claim 1, wherein the initiator device includes a node priority list maintained.

9. The method of claim 1, wherein the communication protocol ranging parameters further include a ranging ID, a hop range maximum distance, and a node retry limit.

10. A networked ecosystem comprising:
an initiator device that supports a first communication protocol;
a target device that supports a second communication protocol; and
a first hop node that concurrently supports the first communication protocol and the second communication protocol, ranging parameters between the initiator device and the target device,
wherein the networked ecosystem is configured to:
generate, at the initiator device that operates according to the first communication protocol, a ranging request that includes a target identifier, a hop-count field, and communication protocol ranging parameters, the communication protocol ranging parameters including a minimum ranging-interval limit, a maximum stable working range, a linear fitted slope, a systemic bias value, and a ranging-result error value;
communicate the ranging request from the initiator device using a first wireless technology;
receive, at a first hop node that concurrently supports the first communication protocol and the second communication protocol, the ranging request;
generate a translated ranging request by mapping, at the first hop node, the communication protocol ranging parameters to second communication protocol ranging parameters using a mapping protocol;
propagate the translated ranging request from the first hop node to one or more additional hop nodes, each additional hop node generating an updated translated ranging request between supported communication protocol and forwarding the updated translated ranging request;
receive, at the target device, the updated translated ranging request using a final communication protocol;
generate, at the target device, a ranging response that includes a ranging response confirmation and timing information related to when the updated translated ranging request was received;
propagate the ranging response from the target device back to the initiator device along the same or an alternative set of hop nodes, each hop node generating a translated ranging response between supported communication protocol; and
compute, at the initiator device, a range between the initiator device and the target device based on the timing information contained in the translated ranging response.

11. The networked ecosystem of claim 10, wherein the first hop node selects the second communication protocol from a group of candidate communication protocol based on an energy level of the one or more additional hop nodes, an available bandwidth related to the candidate communication protocol, and congestion of the candidate communication protocol.

12. The networked ecosystem of claim 10, further comprising updating, at the first hop node and at each of the one or more additional hop nodes, the hop-count field and forwarding the translated ranging request toward the target device using the second communication protocol.

13. The networked ecosystem of claim 12, wherein updating the hop-count field comprises incrementing a hop counter and discarding the translated ranging request when the hop counter exceeds a predefined maximum hop limit.

14. The networked ecosystem of claim 10, wherein the first communication protocol is Wi-Fi, the second communication protocol is Ultra-Wideband™ (UWB), and the final communication protocol is Bluetooth® Low Energy (BLE).

15. The networked ecosystem of claim 10, further comprising authenticating, at each hop node, the ranging request and the ranging response.

16. The networked ecosystem of claim 10, wherein at least one hop is a master node and when no downstream hop node is responsive to the translated ranging request, the master node selects another hop node, and the translated ranging request is re-broadcast.

17. The networked ecosystem of claim 10, wherein the initiator device includes a node priority list maintained.

18. The networked ecosystem of claim 10, wherein the communication protocol ranging parameters further include a ranging ID, a hop range maximum distance, and a node retry limit.

19. Tangible, non-transitory, machine-readable mediums, comprising machine-readable instructions, that when executed by one or more processors, cause the processors to:
generate, at an initiator device that operates according to a first communication protocol, a ranging request that includes a target identifier, a hop-count field, and communication protocol ranging parameters, the communication protocol ranging parameters including a minimum ranging-interval limit, a maximum stable working range, a linear fitted slope, a systemic bias value, and a ranging-result error value;
communicate the ranging request from the initiator device using a first wireless technology;
receive, at a first hop node that concurrently supports the first communication protocol and the second communication protocol, the ranging request;
generate a translated ranging request by mapping, at the first hop node, the communication protocol ranging parameters to second communication protocol ranging parameters using a mapping protocol;
propagate the translated ranging request from the first hop node to one or more additional hop nodes, each additional hop node generating an updated translated ranging request between supported communication protocol and forwarding the updated translated ranging request;
receive, at a target device, the updated translated ranging request using a final communication protocol;
generate, at the target device, a ranging response that includes a ranging response confirmation and timing information related to when the updated translated ranging request was received;
propagate the ranging response from the target device back to the initiator device along the same or an alternative set of hop nodes, each hop node generating a translated ranging response between supported communication protocol; and
compute, at the initiator device, a range between the initiator device and the target device based on the timing information contained in the translated ranging response.

20. The tangible, non-transitory, machine-readable mediums of claim 19, wherein the first hop node selects the second communication protocol from a group of candidate communication protocol based on an energy level of the one or more additional hop nodes, an available bandwidth related to the candidate communication protocol, and congestion of the candidate communication protocol.
